(19) United States
(12) Patent Application Publication
(10) Pub. No.: US 2008/0081240 A1
(43) Pub. Date: Apr. 3, 2008

(54) FUEL CELL STRUCTURE

(76) Inventors: Chien-An Chen, Kaohsiung (TW); Wei-Jui Chuang, Kaohsiung (TW); Chien-Chou Chen, Kaohsiung (TW)

Correspondence Address: G. LINK CO., LTD., 3550 BELL ROAD, MINOOKA, IL, 60447, US

(21) Appl. No.: 11/537,893

(22) Filed: Oct. 2, 2006

(51) Int. Cl. H01M 8/02

(52) U.S. Cl. 429/34; 429/38

(57) ABSTRACT

A fuel cell structure includes at least a cathode passage plate and a load member. The cathode passage plate is capable of transferring chemical energy to electrical power output. The load member receives the cathode passage plate and defines at least a partition for the inner sides of walls of the load member being able to space apart from the cathode passage plate.

### BACKGROUND OF THE INVENTION

1. Field of the Invention

The present invention is related to a fuel cell structure and particularly to a fuel cell structure in which a plurality of cathode passage plates are packaged in a way of a spacing being kept between the walls of the load member and the cathode passage plates next to the walls or between the cathode passage plates.

2. Brief Description of the Related Art

It is known that various portable electronic information products have been developed due to technologies related to electronics, communication and internet progressing rapidly. Usually, the portable products need batteries as power source for supplying electric energy. But, the batteries have limited capacities and become exhausted after being used a period of time. In order to overcome the preceding deficiency of the ordinary batteries, a method for making fuel cell has been disclosed in Taiwanese Patent Official Gazette No. 1241048. The fuel in the cell is a methyl alcohol solution or pure methyl alcohol and a chemical reaction is processed to transfer chemical energy to electric power output. Comparing to the conventional power generation, methyl alcohol cell provides advantages such as low pollution, high energy intensity and higher energy transfer density. Hence, the fuel cell is belonged to leading energy source.

Normally, the preceding fuel cell is composed of a plurality of basic units (the so called cathode passage plates). In practice, voltage supplied by a single basic unit probably is unable to satisfy the power required by the various basic unit probably is unable to satisfy the power required by the various electronic information products, the basic units are often connected in series to comply with the necessary voltage output. Besides, the cathode passage plates generally are packaged with a casing and spacers are employed to partition the cathode passage plates for obtaining sufficient oxygen during the fuel cell performing energy transfer. In order to secure the cathode passage plates and the spacers in the casing, the casing, cathode passage plates and the spacers provide locating holes corresponding to each other to engage with screws.

Unfortunately, the preceding conventional art has to consider the holes corresponding to each other to complicate assembling job during setting up the fuel cell and to increase production cost. Further, it is hard to decide the dimension of the casing according to the rated voltage (Number of the cathode passage plates and spacers changes in accordance with the voltage). Hence, the manufacturing process is incapable of being standardized and it degrade effect of energy transfer done by the fuel cell.

### SUMMARY OF THE INVENTION

Accordingly, an object of the present invention is to provide a fuel cell structure, which has partition part to create spacing between the cathode passage plates or between the packaging casing or the load member and the cathode passage plates.

Another object of the present invention is to provide a fuel cell structure, in which a turbulent parts are arranged at the inner wall surfaces of the packaging load member to decrease air resistance coefficient and guide the fluid moving toward the preset direction in a way of distributing evenly between the cathode passage plates and the load member for promoting effect of energy transfer tremendously.

A further object of the present invention is to provide a fuel cell structure in which a guide flow member is arranged between the cathode passage plates to decrease air resistance coefficient and guide the fluid moving toward the preset direction in a way of distributing evenly between the cathode passage plates and the load member for promoting effect of energy transfer tremendously.

In order to achieve the preceding objects, the fuel cell structure according to the present invention includes at least a cathode passage plate and a load member. The cathode passage plate is capable of transferring chemical energy to electrical power output. The load member receives the cathode passage plate and defines at least a partition for the inner sides of walls of the load member being able to space apart from the cathode passage plate.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a fuel cell according to the present invention;

FIG. 2 is an exploded perspective view of the fuel cell according to the present invention;

FIGS. 3 to 6 are perspective views illustrating the lateral plate shown in FIG. 2 in different structures; and

FIG. 7 is a perspective view of the guide flow plate shown in FIG. 2.

### DETAILED DESCRIPTION OF THE INVENTION

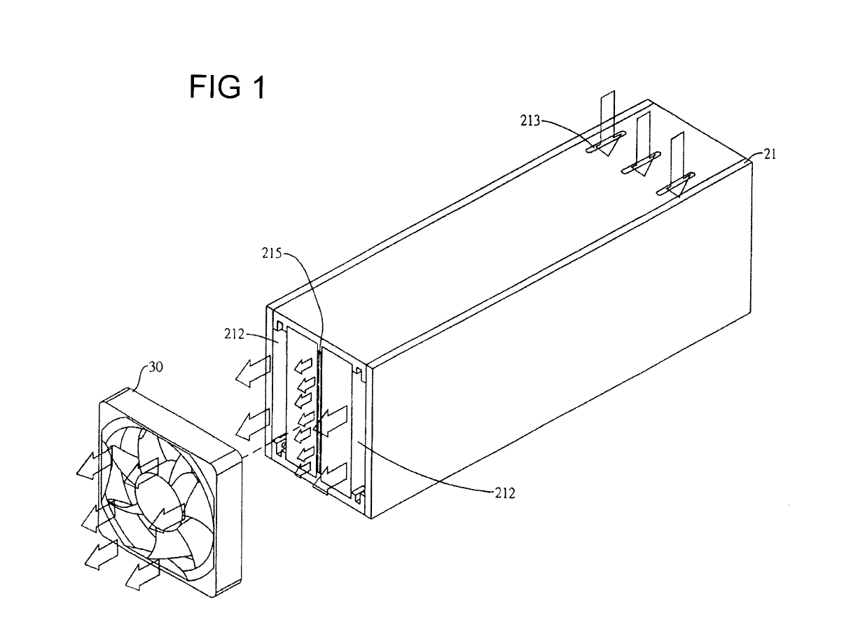

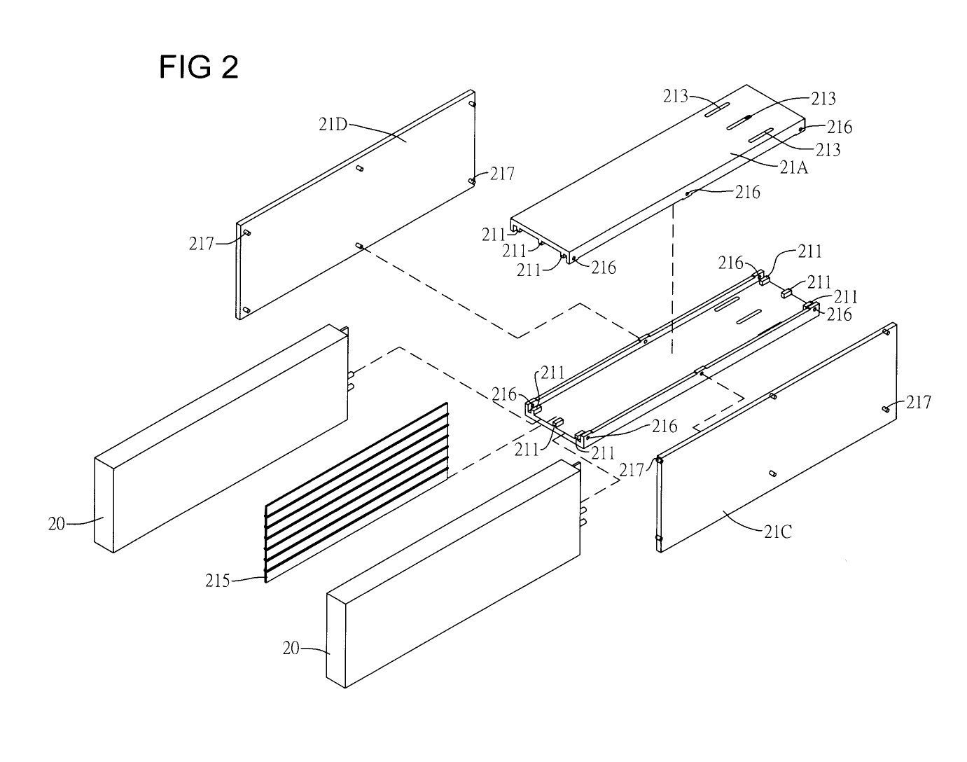

Referring to FIGS. 1 and 2, a fuel cell structure according to the present invention includes at least a cathode passage plate 20 and a load member 21. The cathode passage plate 20 is employed to transfer chemical energy as output power. The load member 21 is employed to receive the cathode flow path plate 20. Besides, the load member 21 defines at least a partition 211 corresponding to the cathode passage plate 20 for supporting and packaging a single or a plurality of cathode passage plates 20 in the load member 21 in a way of a spacing between the cathode passage plates 20 and/or between the respective lateral wall of the load member 21 and the respective cathode passage plate 20 next to the lateral wall. The respective spacing forms a passage for fluid required at the time of the respective cathode passage plate 20 processing energy transfer (chemical energy transferring to electrical energy) being accelerated to pass through and discharge. In case of a single cathode passage plate being packaged in the load member 21, each fuel cell module formed with the single cathode passage plate can be regarded as a completely independent entity. In practice, a certain number of the fuel cell modules can be assembled or packaged based on actual requirement of power to meet flexible demand of the user and share advantage due to standardization of manufacturing process.

The preceding load member 21 is plastic-molded or cast as a casing as shown in FIG. 1 and provides at least an outlet 212 and a inlet 213. The outlet 212 is mounted with a fan 30 such that the fluid needed by the cathode passage plate during energy transfer can enter the load member 21 via the inlet 213 and exit via the outlet 212. The fan 30 speeds up the fluid being guided outward to enhance effect of intake.

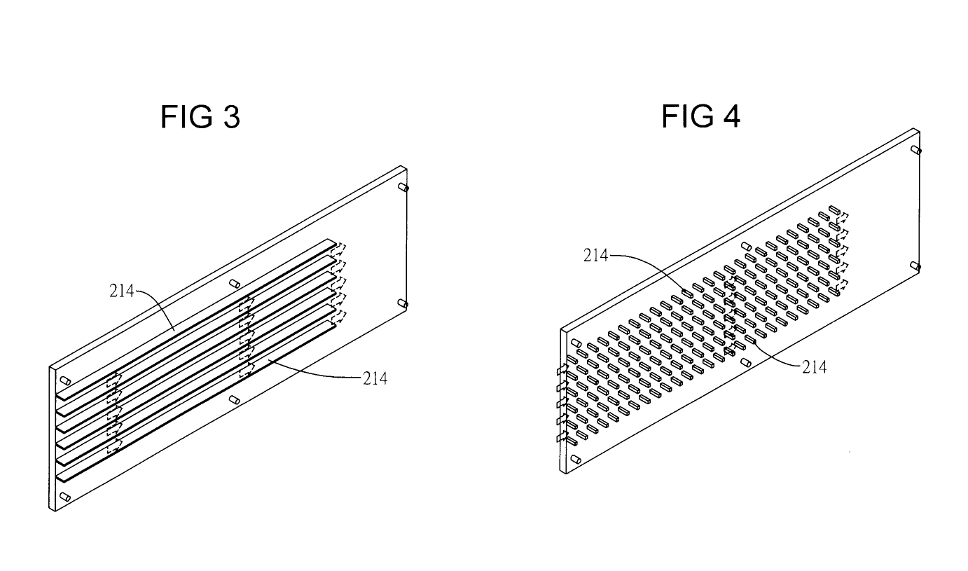

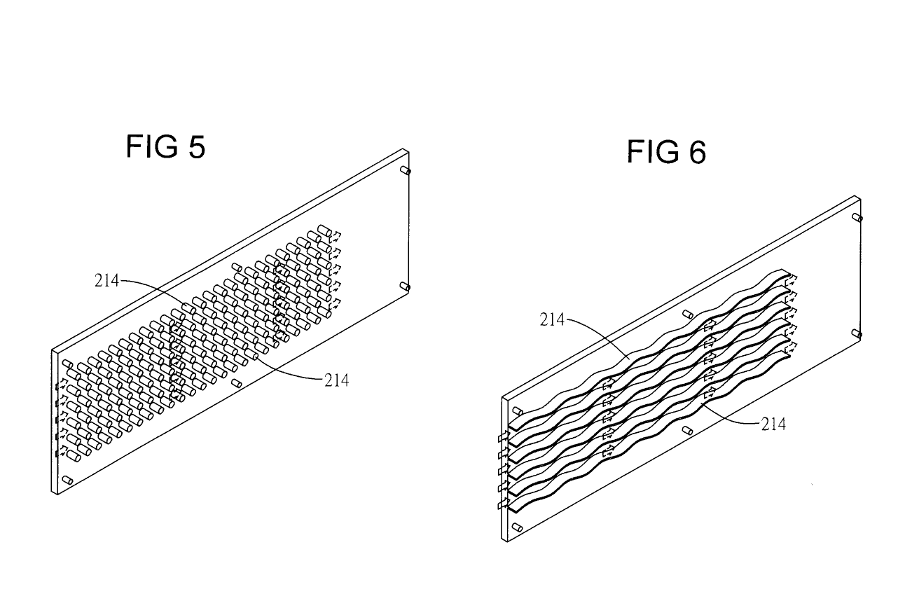

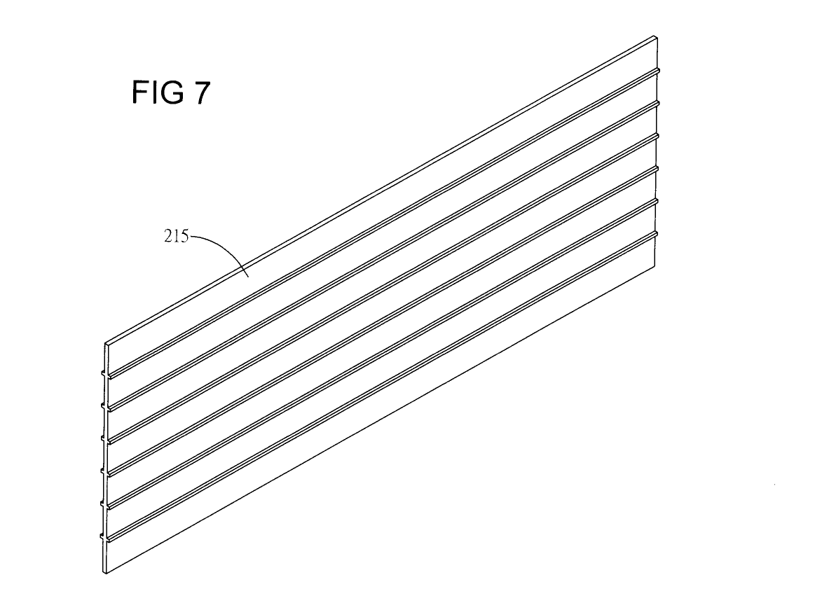

Referring to FIGS. 3 to 6, the inner surface of the lateral wall of the load member 21 is illustrated. At least a turbulent part 214 is attached to the inner surface for the fluid being capable of distributing evenly between the cathode passage plate and the load member. In this way, effect of energy transfer can be promoted tremendously The turbulent part 214 is arranged with a plurality of straight strips as shown in FIG. 3, a plurality of pins as shown in FIG. 4, a plurality of short posts as shown in FIG. 5 or a plurality of wavy strips as shown in FIG. 6 to guide the fluid moving toward a preset direction.

Referring to FIG. 2 again, the load member 21 has an upper cover 21A, a base cover 21B, a first lateral wall 21C, and a second lateral wall 21D. The upper cover 21A and the base cover 21B provide the preceding partition 211 and have locating holes 216 at two opposite longitudinal lateral sides thereof for joining projections 217 provided at the upper and lower sides of the inner surfaces of the first lateral wall 21C and the second lateral wall 21D respectively. When the upper cover 21A and base cover 21B hold a plurality of cathode passage plate 20, the preceding spacing between the cathode passage plates 20 and/or between the cathode passage plates and the first lateral wall 21C and the second lateral wall 21D can be formed due to the partition 211.

The outlet 212 is formed after the upper cover 21A, the base 21B, the first lateral wall 21C and the second lateral wall 21D being set up. The inlet 213 can be arranged at the upper cover 21A as shown in FIGS. 1 and 2. Alternatively, the inlet 213 is capable of being arranged at other places, which are able to result in convection with the outlet 212. Besides, the turbulent part 214 can be arranged at the first lateral wall 21C and the second lateral wall 21D.

Referring to FIG. 7, a flow guide member 215 is illustrated. The flow guide member 215 is placed in a spacing defined by the partition 211 in case of a plurality of cathode passage plate 20 being provided. The wall surface of the flow guide member 215 can be arranged with preceding turbulent part 214 shown in FIGS. 3 to 6 too for the fluid distributing evenly between the cathode passage plates and promoting effect of energy transfer.

While the invention has been described with referencing to preferred embodiments thereof, it is to be understood that modifications or variations may be easily made without departing from the spirit of this invention, which is defined by the appended claims.

What is claimed is:

1. A fuel cell structure, comprising:
at least a cathode passage plate, being capable of transferring chemical energy to electrical power output; and
a load member, receiving the cathode passage plate and defining at least a partition for the inner sides of walls of the load member keeping a spacing to the cathode passage plate.

2. The fuel cell structure as defined in claim 1, wherein the load member at least has an outlet.

3. The fuel cell structure as defined in claim 1, wherein the load member at least has an inlet.

4. The fuel cell structure as defined in claim 1, wherein the inner sides of the two opposite lateral walls provide a turbulent part respectively.

5. The fuel cell structure as defined in claim 4, wherein the turbulent part is arranged with a plurality of strips, pins, short posts or wavy strips.

6. The fuel cell structure as defined in claim 1, wherein the partition allows the spacing being provided between two adjacent cathode passage plates.

7. The fuel cell structure as defined in claim 6, wherein the spacing is available for accommodating at least a guide flow member.

8. The fuel cell structure as defined in claim 1, wherein the load member further comprises:
an upper cover, the inner side thereof being attached with the partition and two opposite longitudinal edges thereof having locating holes;
a base cover, being disposed corresponding to the upper cover, the inner side thereof being attached with the partition as well and two opposite longitudinal edges thereof having locating holes;
a first lateral wall, providing a plurality of projections corresponding to and engaging with the locating holes at the upper cover and the base cover; and
a second lateral wall, being disposed opposite to the first lateral wall and providing a plurality of projections corresponding to and engaging with the locating holes at the upper cover and the base cover too.

9. The fuel cell structure as defined in claim 8, wherein the first lateral wall and the second lateral wall provide the turbulent part at the inner sides thereof respectively.
